(19) United States
(12) Patent Application Publication
(10) Pub. No.: US 2023/0125150 A1
(43) Pub. Date: Apr. 27, 2023

(54) AUGMENTATION OF TESTING OR TRAINING SETS FOR MACHINE LEARNING MODELS

(71) Applicant: Microsoft Technology Licensing, LLC, Redmond, WA (US)

(72) Inventors: Ross CUTLER, Clyde Hill, WA (US); Xavier GITAUX, Burke, VA (US); Jayant GUPCHUP, Bothell, WA (US); Chandan Karadagur Ananda REDDY, Redmond, WA (US)

(73) Assignee: Microsoft Technology Licensing, LLC, Redmond, WA (US)

(21) Appl. No.: 17/503,140

(22) Filed: Oct. 15, 2021

(51) Int. Cl. G06K 9/62; G06N 3/08; G06N 3/04

(52) U.S. Cl. CPC G06K 9/6265; G06K 9/6218; G06K 9/6256; G06K 9/6269; G06N 3/08; G06N 3/0454

(57) ABSTRACT

This document generally relates to techniques for testing or training data augmentation. One example includes a method or technique that can include accessing a repository of private data items. The repository can provide a distribution of the private data items that is representative of a designated real-world scenario for a machine learning model. The method or technique can also include assigning classifications to the private data items in the repository. The method or technique can also include augmenting a testing or training set for the machine learning model based at least on the classifications of the private data items to obtain an augmented testing or training set that is relatively more representative of the distribution of classifications in the repository.

### BACKGROUND

Machine learning can be used to perform a broad range of tasks, such as natural language processing, financial analysis, and image processing. Machine learning models can be trained using several approaches, such as supervised learning, semi-supervised learning, unsupervised learning, reinforcement learning, etc. In approaches such as supervised or semi-supervised learning, labeled training examples can be used to train a model to map inputs to outputs. In unsupervised learning, models can learn from patterns present in an unlabeled dataset.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for augmenting testing or training data sets used to test or train machine learning models. One example includes a method or technique that can be performed on a computing device. The method or technique can include accessing a repository of private data items. The repository can provide a distribution of the private data items that is representative of a designated real-world scenario for a machine learning model. The method or technique can also include assigning classifications to the private data items in the repository. The method or technique can also include augmenting a testing or training set for the machine learning model based at least on the classifications of the private data items to obtain an augmented testing or training set. The augmented testing or training set can provide a basis for testing or training of the machine learning model and can include additional testing or training examples from a particular classification that is unrepresented or under-represented in the testing or training set prior to the augmenting.

Another example includes a system having a hardware processing unit and a storage resource storing computer-readable instructions. When executed by the hardware processing unit, the computer-readable instructions can cause the system to train one or more machine learning models on a testing or training set using one or more tasks. The computer-executable instructions can also cause the system to obtain feature maps for private data items from a repository using the one or more machine learning models. The computer-executable instructions can also cause the system to cluster the private data items into a plurality of clusters based at least on the feature maps, and to augment the testing or training set with additional testing or training examples sampled from the plurality of clusters.

Another example includes a computer-readable storage medium. The computer-readable storage medium can store instructions which, when executed by a computing device, cause the computing device to perform acts. The acts can include providing an input signal into a data enhancement model that has been trained using an augmented training set that includes synthetic training examples that have been augmented with additional training examples from a repository of private data items. The acts can also include outputting an enhanced signal produced by the data enhancement model from the input signal.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example system that can be employed to augment a testing or training data set for one or more machine learning models, consistent with some implementations of the present concepts.

FIG. 2 illustrates an example method or technique for augmenting testing or training sets for one or more machine learning models, consistent with some implementations of the present concepts.

FIG. 3 illustrates an example testing or training data augmentation workflow, consistent with some implementations of the disclosed techniques.

FIG. 4 illustrates an example of sampling audio data items from multiple semantic classifications to augment a testing or training data set, consistent with some implementations of the disclosed techniques.

FIG. 5 illustrates an example of training a clustering algorithm to classify data items, consistent with some implementations of the present concepts.

FIG. 6 illustrates an example of classifying a data item using a trained clustering algorithm, consistent with some implementations of the present concepts.

FIG. 7 illustrates a cluster map of clusters of data items and out-of-distribution data items, consistent with some implementations of the disclosed techniques.

FIG. 8 illustrates an example bar graph of background noise classifications, consistent with some implementations of the disclosed techniques.

FIG. 9 illustrates example graphs of experimental results obtained using the disclosed implementations.

### DETAILED DESCRIPTION

### Overview

Machine learning models can be employed for many applications. One limitation of machine learning is that machine learning models tend to fit to the data used to train the model. As a consequence, a given machine learning model tends to perform well when employed to process inputs similar to the examples that the model has seen during training. However, the machine learning model may not perform as well when employed to evaluate real-world data that is dissimilar from the training data. A related problem occurs when testing or evaluating machine learning models, e.g., if the test set used to evaluate a given model is not representative of the inputs that the model will see in real-world usage, then evaluating the model with that test set may not provide adequate insight as to how the model will perform when employed to operate on real-world data.

For the reasons discussed above, the data sets used to train or test machine learning models will ideally be representative of the real-world data the model will see when employed. However, this is not always the case. For instance, in some cases, testing or training sets are curated by skilled individuals, but even skilled individuals cannot necessarily anticipate all of the scenarios that a model will see when actually employed.

In some cases, private or sensitive sources of real-world data (such as customer data) may be available that are representative of the type of data that a given machine learning model will see when employed. However, due to privacy concerns, it is not always possible to directly employ that data to test or train a given model, e.g., by having users observe and then manually label private data items. Nevertheless, a repository of private data can be used to augment existing testing or training sets to be relatively more representative of real-world conditions that a machine learning model will see when deployed, as described more below.

The disclosed implementations generally offer various techniques to augment existing testing or training data sets to be more representative of real-world environments that a machine learning model will likely process when deployed after training. For instance, the disclosed implementations can perform an analysis of a repository of private data in a privacy-preserving manner and then augment the testing or training sets based on the analysis. The analysis can proceed without allowing users to observe the private data items in the repository and without automated or manual extraction of private information from the repository. The analysis can be used to generate augmented testing or training data sets that may be relatively more representative of the real-world conditions that the machine learning model will see once employed.

As discussed more below, once a given testing or training data set has been augmented, the augmented testing or training data set can be used for various purposes. For instance, augmented data sets can be employed to test or train machine learning models for a specific task. In addition, augmented data sets can be employed to rank various machine-learning models relative to one another, e.g., to select a particular machine-learning model that is suited for a specific real-world application.

The following discussion introduces various data augmentation concepts using audio signals as a primary example. However, as discussed further below, the disclosed techniques can be employed to augment a wide range of testing or training data sets such as, but not limited to, image, video, radar, sonar, or other signals for training or testing of corresponding models that operate on such signals.

### Definitions

For the purposes of this document, the term “signal” refers to a value that varies over time or space. A signal can be represented digitally using data samples, such as audio samples, video samples, or one or more pixels of an image. A “data enhancement model” refers to a model that processes data samples from an input signal to enhance the perceived quality of the signal. For instance, a data enhancement model could remove noise or echoes from audio data or could sharpen image or video data. The term “signal characteristic” describes how a signal can be perceived by a user, e.g., the overall quality of the signal or a specific aspect of the signal such as how noisy an audio signal is, how blurry an image signal is, etc. A “private” data item, such as an audio signal from a customer call, is a data item with at least some constraints (physical, contractual, reputational, etc.) that limit the extent to which the data item can be shared openly with others or processed to extract sensitive information. A “public” data item is a data item that is readily available and can be manually labeled by a user without raising privacy issues.

The term “quality estimation model” refers to a model that evaluates an input signal to determine a quality label for the input signal, e.g., by estimating how a human might rate the perceived quality of the input signal for one or more signal characteristics. For example, a first quality estimation model could estimate the speech quality of an audio signal and a second quality estimation model could estimate the overall quality and/or background noise of the same audio signal. Audio quality estimation models can be used to estimate signal characteristics of an unprocessed or raw audio signal or a processed audio signal that has been output by a particular data enhancement model. The output of a quality estimation model can be a synthetic label representing the signal quality of a particular signal characteristic. Here, the term “synthetic label” means a label generated by a machine evaluation of a signal, where a “manual” label is provided by human evaluation of a signal.

The term “model” is used generally herein to refer to a range of processing techniques, and includes models trained using machine learning as well as hand-coded (e.g., heuristic-based) models. For instance, a machine-learning model could be a neural network, a support vector machine, a decision tree, etc. Whether machine-trained or not, data enhancement models can be configured to enhance or otherwise manipulate signals to produce processed signals. Data enhancement models can include codecs or other compression mechanisms, audio noise suppressors, echo removers, distortion removers, image/video healers, low light enhancers, image/video sharpeners, image/video denoisers, etc., as discussed more below.

The term “impairment,” as used herein, refers to any characteristic of a signal that reduces the perceived quality of that signal. Thus, for instance, an impairment can include noise or echoes that occur when recording an audio signal, or blur or low-light conditions for images or video. One type of impairment is an artifact, which can be introduced by a data enhancement model when removing impairments from a given signal. Viewed from one perspective, an artifact can be an impairment that is introduced by processing an input signal to remove other impairments. Another type of impairment is a recording device impairment introduced into a raw input signal by a recording device such as a microphone or camera. Another type of impairment is a capture condition impairment introduced by conditions under which a raw input signal is captured, e.g., room reverberation for audio, low light conditions for image/video, etc.

The term “real-world scenario,” as used herein, refers to a scenario in which a given model is anticipated to be employed for a particular useful purpose, e.g., by an end user. Generally, machine learning models tend to be employed in real-world scenarios after training or testing. A given repository of data may be “representative” of a real-world scenario when there is a reasonable expectation that the statistical distribution of the data in the repository is similar to the statistical distribution of real-world data that a model will be exposed to when deployed in a real-world scenario. In some cases, the repository may be relatively more representative of the real-world scenario than available testing or training sets for the model. A given classification of data is “under-represented” in a testing or training set when the testing or training set lacks sufficient examples of that classification to accurately test or train the model (e.g., fewer than 10 examples) with respect to data items having that classification. When a testing or training set is augmented with examples from an unrepresented or under-represented classification, the testing or training of the model often becomes more accurate with respect to other data items of the same classification. A given classification of data is “over-represented” when the number of examples of that classification is sufficiently large that the number can be reduced without significantly degrading the testing and/or training value of that dataset. For instance, in some cases, an over-represented classification might have 100 examples in an initial testing or training set, and this number could be reduced to 10 examples in an augmented testing or training set.

### Machine Learning Overview

There are various types of machine learning frameworks that can be trained to perform a given task, such as estimating the quality of a signal or enhancing a signal. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned. Note that two trained models can share the same model structure and yet have different values for the internal parameters, e.g., if the two models are trained on different training data or if there are underlying stochastic processes in the training process.

### Example System

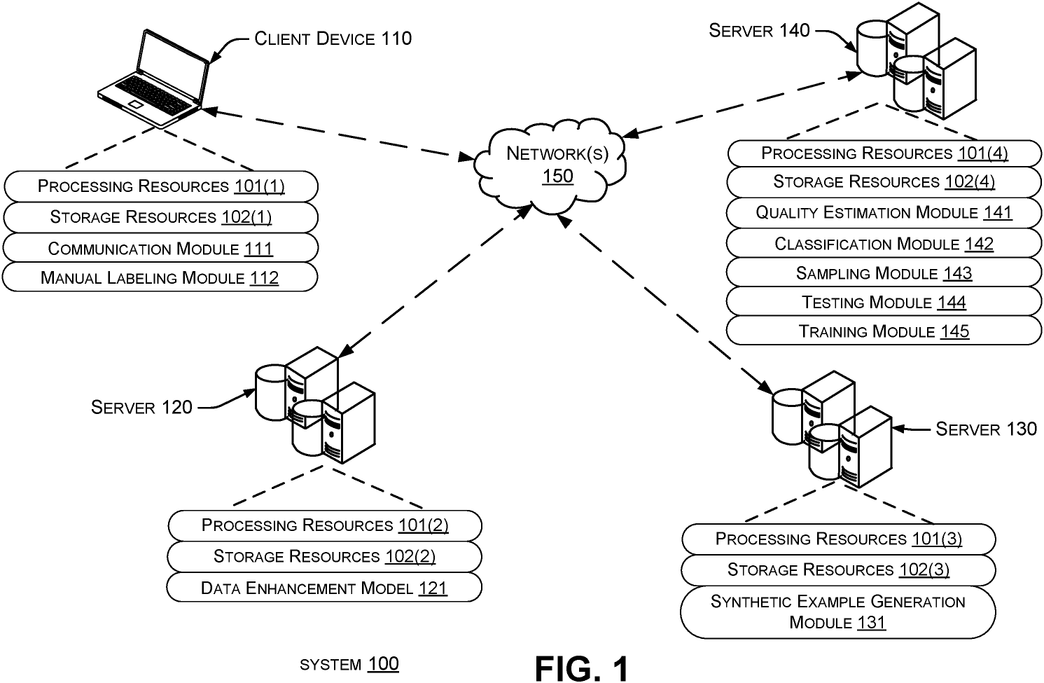

The present implementations can be performed in various scenarios on various devices. FIG. 1 shows an example system 100 in which the present implementations can be employed, as discussed more below.

As shown in FIG. 1, system 100 includes a client device 110, a server 120, a server 130, and a server 140, connected by one or more network(s) 150. Note that the client devices can be embodied both as mobile devices such as smart phones or tablets, as well as stationary devices such as desktops, server devices, etc. Likewise, the servers can be implemented using various types of computing devices. In some cases, any of the devices shown in FIG. 1, but particularly the servers, can be implemented in data centers, server farms, etc.

Certain components of the devices shown in FIG. 1 may be referred to herein by parenthetical reference numbers. For the purposes of the following description, the parenthetical (1) indicates an occurrence of a given component on client device 110, (2) indicates an occurrence of a given component on server 120, (3) indicates an occurrence of a given component on server 130, and (4) indicates an occurrence of a given component on server 140. Unless identifying a specific instance of a given component, this document will refer generally to the components without the parenthetical.

Generally, the devices 110, 120, 130, and/or 140 may have respective processing resources 101 and storage resources 102, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 110 can include a communication module 111 that can allow a human user to communicate with other users, e.g., via voice or audio calls. The voice or audio calls are one example of private data items that can be enhanced and/or employed for augmentation of testing or training sets, as discussed further herein. The client device can also include a manual labeling module 112 that can be used to label data items such as images, audio clips, video clips, etc.

In some cases, the human users evaluate signals produced by using data enhancement model 121 on server 120 to enhance raw input signals. Thus, the manual quality labels provided by the user can generally characterize how effective the respective enhancement models are at enhancing the raw input signals. In other cases, the manual quality labels can characterize the quality of unprocessed (e.g., raw or unenhanced) training signals. The manual quality labels can represent the overall quality of the signals and/or the quality of specific signal characteristics. For audio signals, the manual quality labels can reflect overall audio quality, background noise, echoes, quality of speech, etc. For video signals, the manual quality labels can reflect overall video quality, image segmentation, image sharpness, etc. Note that manual quality labels can also be employed to train a quality estimation model, as discussed more below.

Synthetic example generation module 131 on server 130 can generate synthetic examples for training or testing purposes. For instance, the synthetic example generation module can generate synthetic noisy audio clips from corresponding clean examples by adding noise to the clean examples. In some cases, the clean examples are publicly-available audio clips, and the noise is selected from a set of classifications of specific noise types, e.g., from an ontology or topology of known noise types. In some cases, the noise types available from the ontology or topology lack some types of noise that tend to be present in the audio data produced by the communication module 111 on the client device. Thus, the synthetic examples may not be fully representative of the real-world data produced by the communication model.

Server 140 can evaluate data items, such as audio signals produced by communication module 111 on client device 110, using a quality estimation module 141. The quality estimation module can employ multiple quality estimation models to determine quality labels for individual data items. For instance, a first quality estimation model can evaluate audio signals and output synthetic quality labels that convey the speech quality of the training signals, as estimated by the first quality estimation model. A second quality estimation model can evaluate the audio signals and output synthetic quality labels that convey the overall quality and background noise quality of the audio signals.

Classification module 142 can classify the data items into one or more classifications, e.g., using a clustering approach described in more detail below. Sampling module 143 can sample the data items based on the quality labels and the classifications, as described more below. The sampled data items can be used as additional training or testing examples to augment a testing or training set for a machine learning model, as discussed more below.

Testing module 144 can test one or more models using an augmented testing set. For instance, the testing module can test models individually, or rank a plurality of models relative to one another. Training module 145 can train one or more models using an augmented training set.

For a neural network-based data enhancement model, the training module can adjust internal model parameters such as weights or bias values, or can adjust hyperparameters, such as learning rates, the number of hidden nodes/layers, momentum values, batch sizes, number of training epochs/iterations, etc. The training module can also modify the architecture of such a model, e.g., by adding or removing individual layers, densely vs. sparsely connecting individual layers, adding or removing skip connections across layers, etc. In some cases, the model is a data enhancement model that is evaluated using a loss function that considers synthetic labels output by multiple different quality estimation models of the quality estimation module 141, e.g., speech quality synthetic labels output by a first quality estimation model and overall and background quality synthetic labels output by a second quality estimation model.

### Example Method

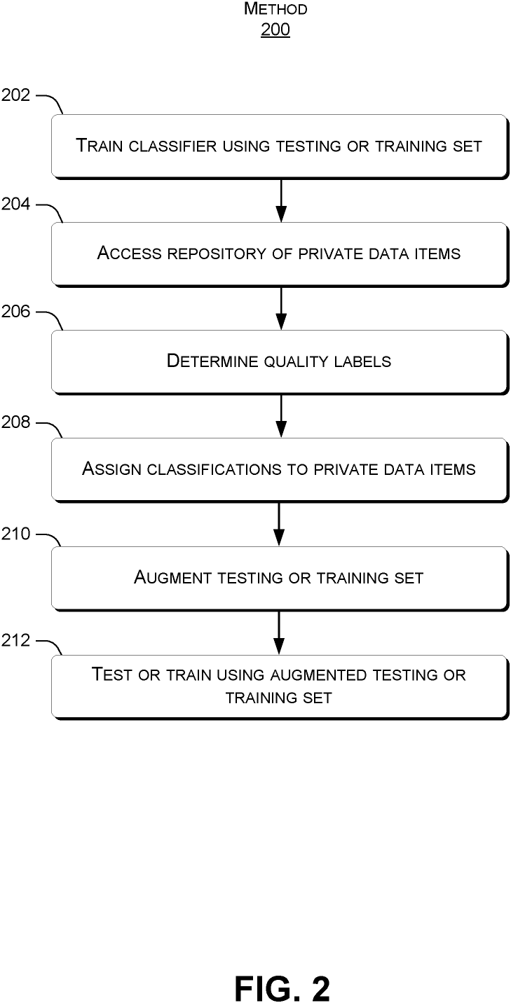

FIG. 2 illustrates an example method 200, consistent with some implementations of the present concepts. Method 200 can be implemented on many different types of devices, e.g., by one or more cloud servers, by a client device such as a laptop, tablet, or smartphone, or by combinations of one or more servers, client devices, etc.

Method 200 begins at block 202, where a classifier is trained to classify testing or training data items from a testing or training set for a machine learning model. For instance, the classifier can be a clustering algorithm trained on synthetic testing or training examples. As discussed more below, the testing or training data examples can be mapped into feature maps in a feature space using one or more tasks, and the feature maps can be clustered by the clustering algorithm. The feature space can be a vector space such that examples with relatively more similar feature maps are located closer together in the vector space.

Method 200 continues at block 204, where a repository of private data items is accessed. For instance, the repository can include private or sensitive data, such as recorded customer voice or audio calls. The repository can be representative of real-world conditions that the machine learning model will be exposed to when deployed.

Method 200 continues at block 206, where quality labels are determined for the private data items in the repository. For instance, the quality labels can be synthetic labels produced by one or more quality estimation models. By using synthetic labels, privacy can be preserved without having users manually label the private data items.

Method 200 continues at block 208, where classifications are assigned to the private data items in the repository. For instance, the private data items can be mapped into the same feature space discussed above with respect to block 202, and feature maps of the private data items can be clustered into clusters with corresponding semantic labels. In some cases, block 208 can include discovering new clusters that were not discovered in block 202, e.g., new noise types of background noise.

Method 200 continues at block 210, where the testing or training set is augmented to obtain an augmented testing or training set. For instance, private data items can be sampled from the repository based on the quality labels and the classifications. The sampling can be weighted using various criteria, such as the quality labels, the classifications, model variance, and/or a designated target distribution (e.g., uniform or weighted to a specific application scenario), as discussed more below.

Generally speaking, the augmented testing or training set can include additional testing or training examples from a particular classification that is unrepresented or under-represented in the testing or training set prior to the augmenting. One way to achieve this involves utilizing sampling from each classification using a sampling probability that is proportional to the number of examples in that classification, as discussed more below. The augmented testing or training set can also have a reduced number of testing or training examples from an over-represented classification, relative to the original testing or training set. One way to achieve this involves replacing examples from the original testing or training set with the additional testing or training examples.

Note that the additional testing or training examples do not necessarily need to be obtained from the private data items. In other embodiments, synthetic training examples can be generated for classifications identified at block 208 that are unrepresented or under-represented in the testing or training set. By generating synthetic examples in this manner, the testing or training set can be augmented to be more representative of the distribution of classifications in the private data items, without actually using the private data items themselves in the augmented testing or training set.

Method 200 continues at block 212, where a model is tested or trained using the augmented testing or training set. For instance, multiple models can be ranked relative to one another based on their performance on the augmented testing or training set. Alternatively or in addition, individual models can be trained from scratch on the augmented testing and training set, or tuned on the additional examples that are added at block 210.

Blocks 202 and 208 of method 200 can be performed by classification module 142. Blocks 204 and 210 of method 200 can be performed by sampling module 143. Block 206 of method 200 can be performed by quality estimation module 141. Block 212 of method 200 can be performed by testing module 144 or training module 145.

### Example Sampling Workflow

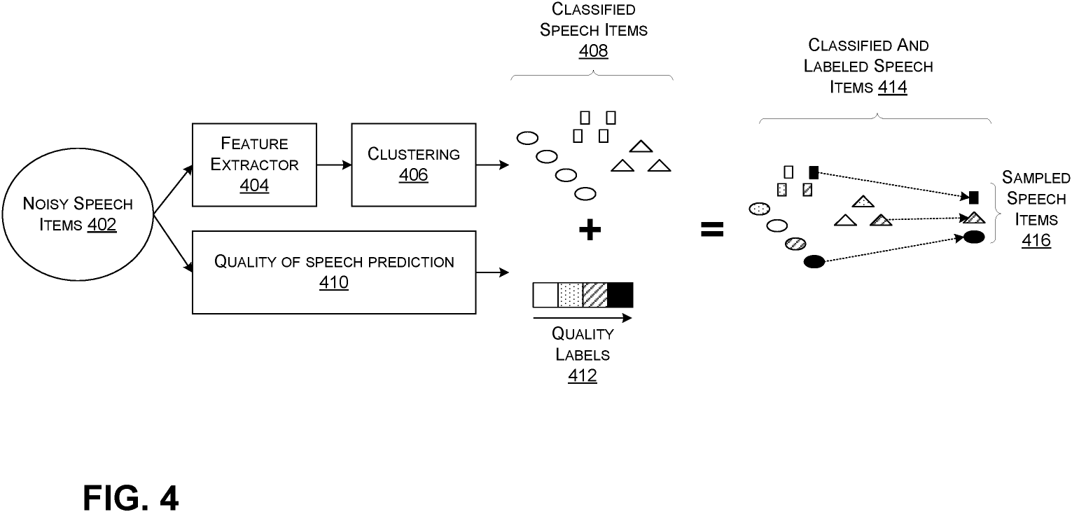

FIG. 3 illustrates an example sampling workflow 300 for augmenting a testing or training set, consistent with some implementations of the present concepts.

A private data repository 302 is accessed and candidate samples 304 are retrieved. The candidate samples can be private data items that are input to quality estimation 306 to obtain corresponding quality labels 308. In some cases, quality estimation involves labeling the candidate samples with one or more synthetic quality labels using a machine learning model, where each synthetic quality label conveys the quality of a corresponding characteristic of the candidate sample.

The candidate samples 304 can also be input to a classifier 310 to obtain classifications 312. Prior to sampling, classifier 310 can be trained by inputting synthetic data items 316 from a synthetic training or testing set 318 into training 320. The training can produce model parameters 322 for the classifier. As noted previously, classification can be performed using a clustering approach, but can also be performed using a classifier such as a neural network, trained using supervised learning with manually or synthetically labeled examples.

The candidate samples 304, quality labels 308, and classifications 312 can be input to sampler 314. The sampler can employ the classifications produced by the classifier 310 together with the quality labels 308 to identify selected samples 324 for inclusion in an augmented testing or training set 326. The augmented testing or training set can also include some or all of the synthetic data items 316 from the synthetic training or testing set 318. The augmented testing or training set can be employed for training or testing of various models, as described elsewhere herein.

### Example Speech Sampling

The previous discussion introduced various concepts that can be employed on a wide range of data types. The following introduces more specific examples to illustrate how the above concepts can be employed to sample speech data items for testing and/or training of noise suppressors.

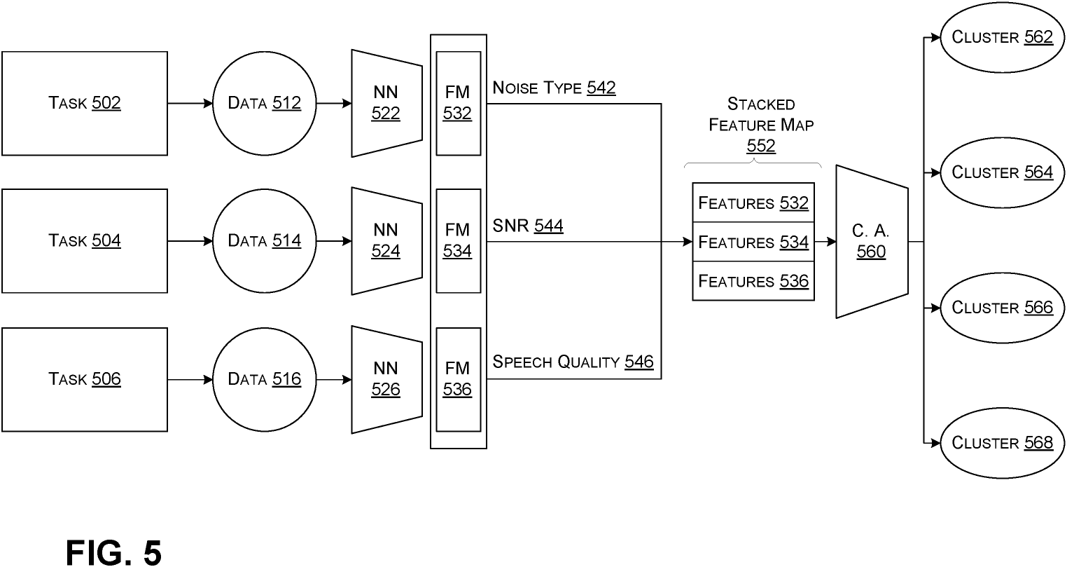

FIG. 4 illustrates an example of sampling of speech data items, e.g., from customer data of audio or video calls between various customers. First, noisy speech items 402 are selected, e.g., using a binary classifier to filter out any speech items deemed clean (e.g., noise below a threshold) by the binary classifier. Next, the noisy speech items are input to feature extractor 404 and clustering 406, and the noisy speech items are assigned classifications to obtain classified speech items 408. FIG. 4 shows three different classifications with corresponding shapes, e.g., triangles, rectangles, and ovals. For instance, the different classifications could be different noise types or other classes represented via feature maps of the noisy speech items.

In addition, the noisy speech items 402 are input to quality of speech prediction 410, which outputs quality labels 412 for each noisy speech item. The quality labels are shown as being relatively darker for lower-quality (e.g., lower speech quality) data items.

Then, the classified and labeled speech items 414 are sampled using a weighted sampling function to obtain sampled speech items 416. The sampling function can give a relatively higher priority or weighting for data items with relatively low quality, with consideration to ensuring each classification is adequately represented in the final sample. Generally speaking, prioritizing selection of lower-quality samples can provide samples with more training or testing value, as more difficult samples are likely to result in greater model error than less difficult samples. Each selected sample can be added to an existing testing or training set for any model that is used to process speech data, such as noise suppressors or other audio-enhancing models.

### Example Classification Model Training

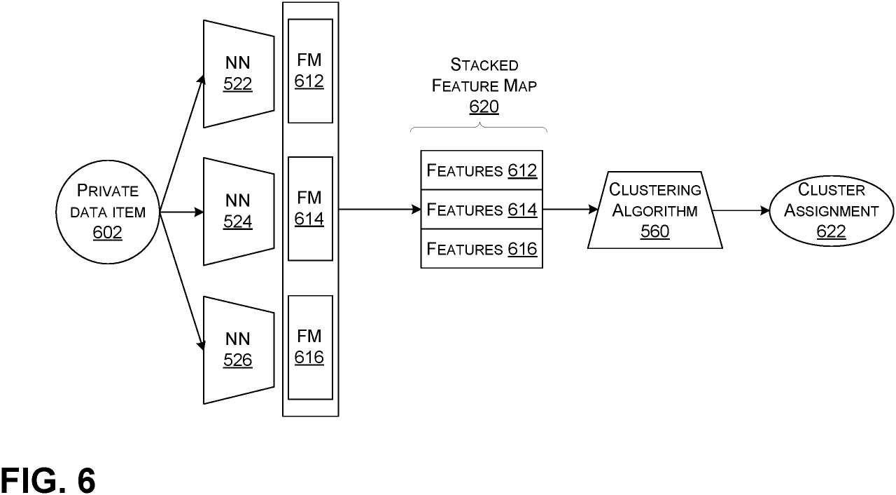

FIG. 5 shows an example of training a classifier using a clustering algorithm. First, tasks 502, 504, and 506 are performed on one or more data sets. For instance, task 502 can include noise type classification, task 504 can include estimating signal-to-noise ratio, and task 506 can include estimating speech, background, and/or overall quality. Data sets 512, 514, and 516 for each task can be input into corresponding neural networks 522, 524, and 526. Each neural network produces corresponding feature maps 532, 534, and 536, e.g., vector embeddings of each respective data item. Neural network 522 can estimate a noise type 542 using feature map 532, neural network 524 can estimate a signal-to-noise ratio 544 using feature map 534, and neural network 526 can estimate speech quality 546 using feature map 536. Note that data sets 512, 514, and 516 can include testing or training sets for a machine learning model that will be tested or trained using an augmented data set but can also include other suitable data sets.

The corresponding feature maps 532, 534, and 536 produced by the respective neural networks can be combined into a stacked feature map 552 for each data item. Clustering algorithm 560 can be performed on the stacked feature map to output corresponding clusters 562, 564, 566, and 568. Each cluster can include data items with different labels produced by the neural networks, e.g., one cluster might include audio signals with an alarm clock in the background as predicted by neural network 522, low signal-to-noise ratios as predicted by neural network 524, and low speech quality as predicted by neural network 526. A second cluster might include audio signals with rain in the background as predicted by neural network 522, medium signal-to-noise ratio as predicted by neural network 524, and medium speech quality as predicted by neural network 526. Note that neural network 526 can be a quality estimation model as discussed elsewhere herein, whereas noise type prediction by neural network 522 and signal-to-noise prediction by neural network 524 can be considered auxiliary tasks that are selected to produce corresponding feature maps. In some cases, selection of auxiliary tasks may be a matter of convenience, e.g., if there are readily-available models and training data for a given task that operates on a particular type of data item (e.g., audio data), then that task may be selected as an auxiliary task for generating feature maps for subsequent clustering.

### Example Data Item Classification

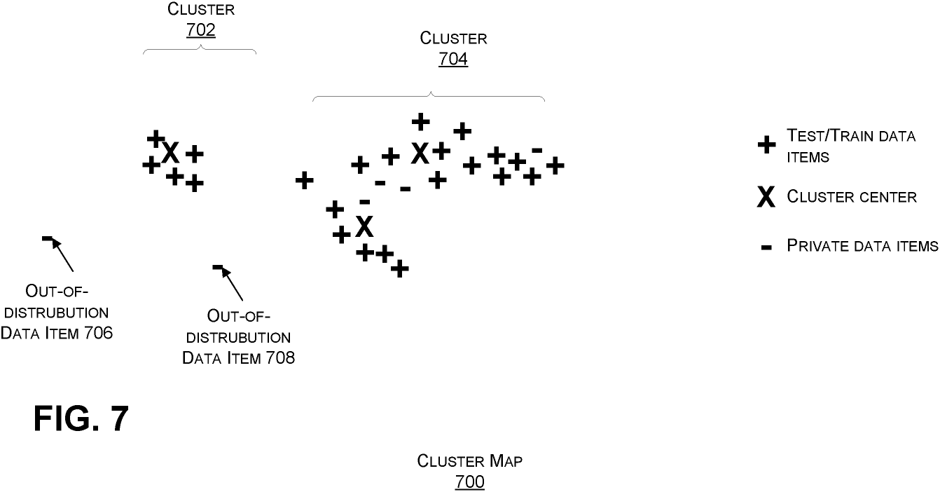

FIG. 6 shows an example of using a classifier to classify a private data item 602. A private data item (e.g., an audio signal from a call) is input to the three trained neural networks described previously (522, 524, and 526) to obtain corresponding feature maps 612, 614, and 616. The feature maps are combined into a single stacked feature map 620. The stacked feature map is input to clustering algorithm 560, which outputs a cluster assignment 622 for that data item. In some cases, instead of assigning a data item to a specific cluster, the clustering algorithm indicates that the data item is out-of-distribution, as described more below.

### Example Cluster Map

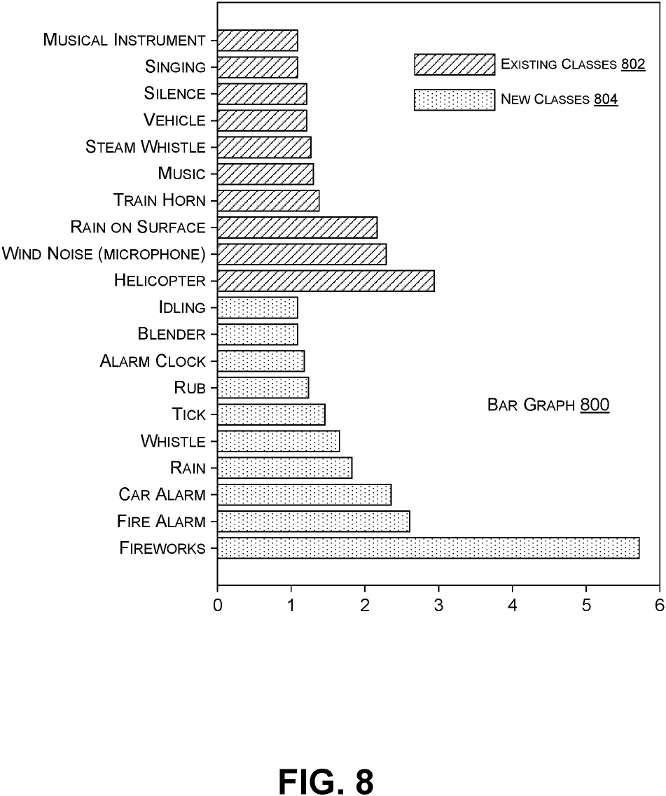

FIG. 7 shows an example cluster map 700, reflecting a distribution of data items. There are two clusters 702 and 704 illustrated, as well as two out-of-distribution data items 706 and 708. For instance, these two clusters can represent noise classifications that were well-represented in a given data set, e.g., an alarm clock or rain in the background, as mentioned previously. Out-of-distribution data items 706 and 708, on the other hand, can represent data items that do not fall into any existing classification.

In some cases, multiple out-of-distribution data items can be identified that are relatively close to one another and then designated as a new cluster. For instance, assume that out-of-distribution data item 706 has a vehicle in the background, and that there is only one such example in the testing or training data set. When classifying private data items from the repository, it may become apparent that vehicle background noise is actually relatively common in real-world noise suppression scenarios, as multiple private data items appear on cluster map 700 in the vicinity of out-of-distribution data item 706. In such a case, additional testing or training examples with vehicle noise in the background can be added to the testing or training set since this noise type is under-represented in the original testing or training set, either by sampling private data items with background vehicle noise or generating synthetic examples with background vehicle noise.

### Example Distribution of Noise Categories

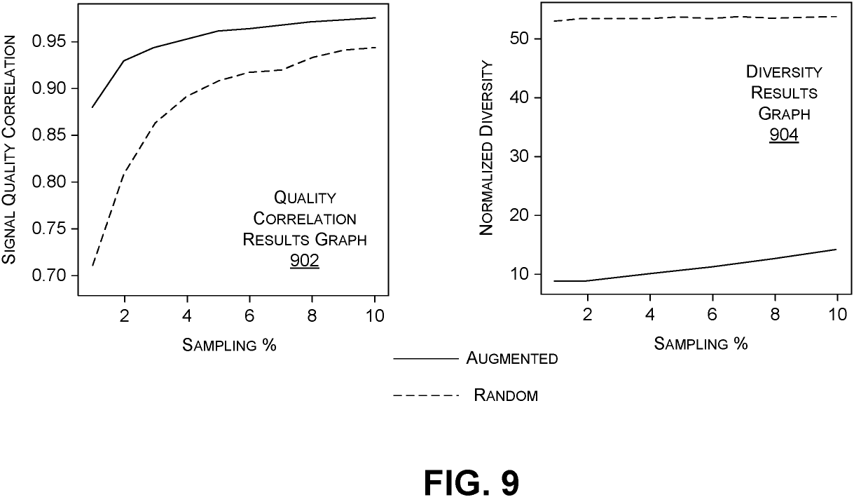

FIG. 8 shows a bar graph 800 of example noise types that can be identified by clustering of audio signals. The bar graph shows existing classes 802 that are present in an original testing or training set, and new classes 804 that are discovered as new clusters in the private data items from the repository. Bar graph 800 also shows the relative size of each cluster, which conveys how frequently each classification of noise occurs.

In some cases, an assumption can be made that a private data repository is adequately representative of future real-world conditions that a model will be exposed to when the model is deployed. For instance, one might assume that voice calls recorded during the past few years would have a similar distribution of noise categories as voice calls that will occur in the next few years. Thus, one could use recent historical call data to test or train a noise suppressor or other model that operates on the voice calls. However, in some cases, there may be a reason to adjust the distribution for the augmented testing or training set based on an expectation that the noise suppressor or other model will be deployed under different conditions than those represented in the repository of private data items.

For instance, consider the recent pandemic, which resulted in more users working from home. Assume the private data repository includes mostly private calls from users working in their offices before the pandemic, but the noise suppressor or other model will be deployed in the future now that workers tend to work from home much more frequently than in the recent past. Thus, it may be useful to adjust the distribution of the augmented testing and training set to account for this change in real-world conditions. For instance, it might be useful to include more examples of noises that tend to occur when users are working at home (e.g., dogs barking, babies crying, etc.) and fewer examples of noises that tend to occur when users are in the office (e.g., fax or copy machines, elevator chimes, etc.).

### Specific Quality Evaluation Model

The following discussion presents specific quality evaluation models (referred to below as “DNSMOS or DNSMOS P.835”) that can be employed for evaluating noise-suppressed audio signals. Noise-suppressed audio recordings are obtained by inputting noisy audio signals into a plurality of noise suppressors with different characteristics, e.g., that tend to introduce different types of artifacts when suppressing noise. The noise-suppressed audio recordings can be manually labeled with very poor quality labels (Mean Opinion Score or MOS=1) to excellent (MOS=5) for three different signal characteristics - speech quality (SIG), background noise quality (BAK), and overall quality (OVRL). Note that the manually-labeled data set for training DNSMOS can be publicly-available data items to mitigate privacy concerns involved with manual labeling. The manually-labeled data can implement manual labeling in accordance with the subjective test ITU-T P.835. Additional details are available at ITU-T Recommendation P.835, Subjective test methodology for evaluating speech communication systems that include noise suppression algorithm, International Telecommunication Union, Geneva, 2003.

The architecture for a specific convolutional neural network that can evaluate audio signal quality is shown below in Table 1. The input to the model is log power Mel Spectrogram with 320 FFT size computed over a clip of length of 9 seconds sampled at 16 kHz with a frame size of 20 ms and hop length of 10 ms. This results in an input dimension of 900 × 161. Two different models with almost the same architecture except for the last layer can be trained. One model is trained to predict 3 outputs (SIG or speech quality, BAK or background noise quality, and OVRL or overall quality, which is a combination of SIG and BAK) and the other model is trained to predict only SIG, as prediction of SIG may be a harder task as SIG is less correlated with BAK and OVRL. Both models can be trained with a batch size of 32 and a mean squared error loss function until the loss is saturated, without feature normalization.

TABLE 1

| | |
|---|---|
| Layer | Output dimension |
| Input | 900 × 120 × 1 |
| Conv: 128, (3 × 3), ‘ReLU’ | 900 × 161 × 128 |
| Conv: 64, (3 × 3), ‘ReLU’ | 900 × 161 × 64 |
| Conv: 64, (3 × 3), ‘ReLU’ | 900 × 161 × 64 |
| Conv: 32, (3 × 3), ‘ReLU’ | 900 × 161 × 32 |
| MaxPool: (2 × 2), Dropout(0.3) | 450 × 80 × 32 |
| Conv: 32, (3 × 3), ‘ReLU’ | 450 × 80 × 32 |
| MaxPool: (2 × 2), Dropout(0.3) | 225 × 40 × 32 |
| Conv: 32, (3 × 3), ‘ReLU’ | 112 × 20 × 32 |
| MaxPool: (2 × 2), Dropout(0.3) | 112 × 15 × 32 |
| Conv: 64, (3 × 3), ‘ReLU’ | 112 × 20 × 64 |
| GlobalMaxPool | 1 × 64 |
| Dense: 128, ‘ReLU’ | 1 × 128 |
| Dense: 64, ‘ReLU’ | 1 × 64 |
| Dense: 1 or 3 | 1 × 1 or 1 × 3 |

Similar models can be developed for other impairment types such as network distortions, codec artifacts, and reverberation for audio, or other characteristics of image/video signals as described elsewhere herein.

### Specific Data Enhancement Model

As discussed above, one specific example of a type of data enhancement model is a noise suppressor. The following describes a specific implementation of a noise suppressor. A noise suppressor can receive an input signal that is input to a feature extraction layer, where features are extracted. The features can include short-term Fourier features, log-power spectral features, and/or log power Mel spectral features which can be extracted. A series of gated recurrent units can process the extracted features and provide output to the next gated recurrent unit in the series. The output of the last gated recurrent unit can be input to an output layer that produces a noise-suppressed signal. Note that this is but one example of a noise suppression model structure, and in some cases other layers can also be employed, such as pooling and/or convolutional layers.

As noted previously, a data enhancement model such as a noise suppressor can be trained using synthetic examples with synthetically-added noise, and/or using synthetic labels. For instance, synthetic examples can be generated for different classes of noise that are present in an ontology and/or discovered by clustering private data items. In some cases, a skilled individual might obtain noise clips of the noise classifications and add those noise clips to publicly-available clips of clean speech.

A data enhancement model can also be trained using synthetic labels for different signal characteristics that are provided by a quality evaluation model, as described herein. For instance, a loss function can be defined over the synthetic labels for one or more signal characteristics. Then, the data enhancement model can be employed to enhance signals in an augmented training set while back-propagating error from the loss function to adjust internal model parameters. For instance, a noise suppression model could have a loss function that considers synthetic speech quality labels produced by a model with a single output layer and synthetic background and overall quality labels produced by another model with multiple output layers. In some cases, data enhancement models can be adapted in other ways, e.g., by changing the architecture of the model.

### Specific Pipeline and Sampling Algorithm

In some specific implementations, an objective is defined to estimate a performance metric ρ of noise suppression on a target data Dₜ that represents real-world conditions. For instance, consider performance metrics ρ that can be derived from speech quality as measured by a subjective listening protocol that follows the P.835 framework. For each speech clip i, the protocol generates a mean opinion score MOS for signal quality

$$M O {S}_{i}^{s i g}$$

, background noise

$$M O {S}_{i}^{b a k}$$

and overall quality

$$M O {S}_{i}^{o v r}$$

. Two performance metrics ρ can be derived from MOS: (i) differential MOS (dMOS) between after and before denoising; (ii) stack ranking of competing noise suppressors according to their average dMOS calculated on the target data Dₜ.

The disclosed implementations can operate under constraints such that a small subset S of files is be sampled out of all the noisy speeches in Dₜ; and, that audio files in Dₜ are not used to fit a model that encodes identifiable private information in its parameters. The restriction |S| « |Dₜ| limits the size of the test set and allows rapid testing of models during development.

The disclosed implementations aim to obtain a sampling estimate of the performance metric ρ with a small error ε compared to the expected value of ρ on the target data Dₜ. To reduce or minimize ε, the disclosed implementations can trade-off bias and variance. A random sample of Dₜ audio files can result in zero bias, but high variance. On the other hand, probability-proportional-to-size sampling (PPS) can reduce or minimize the variance of the estimator by sampling audio files with a probability proportional to ρ. However, one shortcoming of PPS sampling performed solely on ρ is that it does not consider the diversity of scenarios.

To trade-off variance and bias, the disclosed implementations can utilize the pipeline discussed above with respect to FIG. 4. The pipeline learns a partition of the target data into k clusters in an embedding space obtained from a pre-trained feature extractor. Then, the pipeline can apply PPS to each cluster. Thus, audio files can be sampled in two steps. First, files can be sampled from all the clusters of the embedding space to capture the diversity represented in the target data. Second, within each cluster, the sampling favors audio files with the largest ρ to reduce the variance of the performance metric ρ.

One application of the disclosed sampling techniques involves sampling |S|f audio files in the target data Dₜ to form a test set for testing of noise suppression models. In each of the k clusters of the embedding space, the disclosed implementations can sample |S|/k files with a probability inversely proportional to their predicted dMOS. The smaller the dMOS is, the more challenging the noisy speech is. Negative dMOS indicates a degradation of speech quality by the noise suppressor.

One evaluation task in noise suppression is to compare the speech quality produced by different models on the same audio file. Given N noise suppressors, step 4 of the above pipeline can be adjusted by sampling within each cluster audio file with a probability proportional to the variance across models of the predicted dMOS for a given audio file. Instead of the sampling error (1), sampling performance can be measured with the Spearman’s rank correlation coefficient between the ranking of the N models obtained on the sample S and the ranking obtained with the entire target data Dₜ.

### Specific Pipeline and Dataset Examples

The following section presents a specific implementation of the pipeline discussed above.

A feature extractor can be constructed from a pre-trained VGGish model, details available at: Shawn Hershey, et al., “CNN Architectures for Large-Scale Audio Classification,” IEEE International Conference on Acoustics, Speech and Signal Processing (ICASSP), pp. 131-135, 2017, which is a classification model that can be trained on 100 M YouTube videos. This model generates, for each audio file, a 128-dimension embedding. VGGish embeddings are trained toward identifying the type of foreground sound in an audio file. In the context of noise suppression, it is of interest to detect the noise in the background of a speech. Therefore, the feature extractor can be tuned by using its embedding as inputs to two fully connected layers and by classifying the type of background noise.

1.5 million examples of 10 s noisy speeches were synthesized using 527 categories of noise sounds from Audioset, details of which are available at Jort F. Gemmeke, et al., “Audio Set: An Ontology and Human-Labeled Dataset for Audio Events,” Proc. IEEE ICASSP 2017, New Orleans, LA, 2017 (hereinafter “AudioSet”). These noise sounds were added to the background of clean speeches randomly drawn from a library of clean speeches in Chandan KA Reddy, et al., “Interspeech 2021 Deep Noise Suppression Challenge,” arXiv preprint arXiv:2101.01902, 2021 (hereinafter “Interspeech 2021”). The background noise type classifier trained on this synthetic data achieved a mean average precision (MAP) of 0.33 and area-under-the-curve (AUC) of 0.96 on a hold-out sample. The background noise type classifier also provides a feature extractor that map noisy speeches to a 128- dimension embedding space that is semantically aligned with the type of background noise. Using kmeans + + on the embedding space, the 1.5 million noisy speeches were partitioned into 256 clusters. The quality of the clusters was validated with the following protocol. For a random sample of files in the synthetic data, 24 random clusters were listened to, and 80% of the clusters share a common background noise.

Experiments were conducted on two different data sets. First, the experiments produced an augmented DNS (deep noise suppression) challenge test set. A target augmented dataset was created by augmenting the test set from the DNS challenge from Interspeech 2021 with additional noisy speech. These additional noisy speeches were generated by mixing sounds from the balanced Audioset data with clean speech from Chandan KA Reddy, et al., “ICASSP 2021 Deep Noise Suppression Challenge,” ICASSP 2021, IEEE, pp. 6623-6627, 2021 (hereinafter “ICASSP Challenge”). Segments following ICASSP Challenge from Audioset were used as background noise to generate noisy speeches with signal-to-noise ratio (SNR) between -5 dB and 5 dB. The resulting target data combines 1.7 K files from the DNS challenge test set with 22 K of 10 second clips from the newly synthesized noisy speech that covers 527 noise types with at least 59 clips per class. The pool of noisy speech candidates is at least partially out-of-distribution compared to the Interspeech 2021 data set, which covers 120 noise types. Moreover, the resulting target data does not overlap the dataset of audio clips used to fine-tune the feature extractor and train quality estimation models DNSMOS P.835 and thus, reproduces the conditions of an ‘ears-off’ environment.

Second, experiments were conducted on the augmented DNS challenge test set + clean speeches. For each noisy speech in the previous target data, 10 clean speech clips from Interspeech 2021 were randomly drawn. Clean speech presents a challenge to stack rank models in development because it is not very useful for discriminating the performance of noise suppressors.

### Example Experimental Results

Experiments were conducted to determine whether the disclosed implementations can generate a test set of the same size as the Interspeech 2021 benchmark set, but with more challenging and diverse examples. The diversity of the resulting sample was measured as the x² distance between the distribution of audio segments across the embedding clusters and a uniform distribution between clusters. The value was normalized by calculating χ² of the contingency table over the percentage of data points in each cluster rather than raw frequency. The lower the x² distance, the more audio properties encoded in the embedding space the resulting test set covers and thus, the more diverse the conditions captured by the test set are.

Table 2 below compares dMOS and x² for the benchmark test set (top row) and the test set using the disclosed implementations (bottom row). The proposed test set replaces 73% of noisy speech in the benchmark test set with new noisy speech from synthetic data. The disclosed implementations form a test set with clips for which noise suppressors are more likely to degrade the signal and overall quality of the speech than in the benchmark dataset. Moreover, the test set generated using the disclosed implementations has a x² distance that is not significantly different from zero p - value > 0.05, which indicates good coverage of all clusters in the embedding space and thus, a diverse set of audio conditions.

Results in Table 2 show how sampling the most challenging audio files in each cluster improves diversity (x² distance decreases from 3843 to 287) compared to a sampling procedure that only selects the most challenging files without diversity constraint (second row in Table 2).

TABLE 2

| Test Set | dMOS | | | x² | OOD% |
|---|---|---|---|---|---|
| | Sig | Back | Ovr | | |
| DNS Challenge | -0.24 | 0.99 | 0.18 | 498 (0.05) | 0/100 |
| Proposed w/o Clustering | -0.57 | 0.91 | -0.32 | 3843 (0.001) | 69/31 |
| Proposed w/ Clustering | -0.47 | 0.89 | -0.18 | 287 (>0.2) | 73/27 |

Referring back to FIG. 8, which shows noise classifications of noisy speeches that are sampled by the disclosed implementations (e.g., the 10 largest clusters) to be added to the test set. The disclosed techniques can prioritize new out-of-distribution audio scenarios since the top-10 noise types selected by the disclosed implementations from the augmenting dataset correspond to categories that were not included in the benchmark test set.

Sampling efficiency was also evaluated to accurately stack rank noise suppression models with few samples S from the target data Dₜ. The objective here is to estimate a model ranking that has a high Spearman correlation with the ranking that would be obtained on the entire data. For each speech sample, 28 noise suppression models from Interspeech 2021 were run and the dMOS predicted by the DNMOS P.835 model was obtained. The sampling was bootstrapped 200 times, and the mean and standard deviation of the resulting rank correlation coefficients were determined. The disclosed sampling implementations were compared to three alternative strategies: (i) Random, which draws randomly 1% of data; (ii) Diversity, which samples uniformly across embedding clusters; (iii) Variance, which samples proportionally to the variance of predicted DMOS across the 28 models.

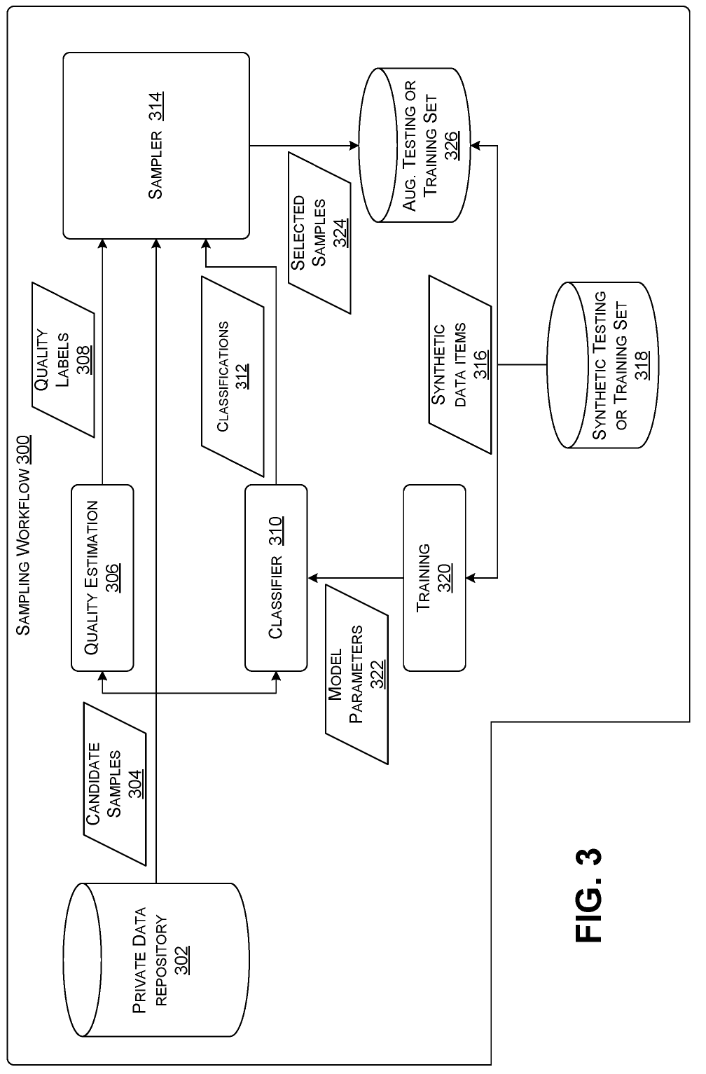

Table 3 below shows the Spearman’s rank correlation coefficient for ranking based on signal, background and overall dMOS. Sampling using the disclosed techniques (referred to as “Aura” in Table 3) leads to a 26% improvement over random sampling for signal-based ranking. Note that the 95% confidence interval of the ranking obtained from samples using the disclosed techniques is narrower than the one obtained by random sampling. Compared to alternative approaches, the disclosed implementations generate the sample with the lowest x² distance, which indicates a better coverage of audio scenarios. On the other hand, Random has the highest x² distance because it mostly samples clean speeches. FIG. 9 provides quality correlations results graph 902 and diversity results graph 904. These results show that, for larger samples, the disclosed implementations keep outperforming Random both in terms of rank correlation and x² distance.

TABLE 3

| Sampling Method | SRCC | | | x² × 10³ |
|---|---|---|---|---|
| | SIG | BAK | OVR | |
| Random | 0.58±0.02 | 0.72±0.01 | 0.72±0.02 | 9±0.01 |
| Diversity | 0.72±0.02 | 0.89±0.01 | 0.82±0.01 | 4±0.02 |
| Variance | 0.80±0.01 | 0.93±0.01 | 0.88±0.01 | 7±0.02 |
| Aura | 0.84±0.01 | 0.93±0.01 | 0.91±0.01 | 1±0.01 |

### Technical Effect of Augmenting Testing or Training Sets

As previously noted, machine learning models can tend to overfit to a training dataset, and do not generalize well to unseen data when deployed in real-world conditions. Likewise, testing of machine learning models on test sets that are not representative of real-world conditions can lead to incomplete or faulty test results.

The disclosed implementations aim to mitigate these issues by augmenting testing or training data sets with additional examples from classifications that are unrepresented or under-represented in the original testing or training sets, and/or removing examples from classifications that are over-represented in the original testing or training sets. By using an unsupervised clustering approach trained on a separate (e.g., public) data set to discover new, over-represented, or under-represented classifications in private data items, the disclosed implementations can preserve privacy of the private data items while still providing insight into the distribution of classifications that a given model will likely see in real-world usage. Further, additional testing or training examples can be added to the testing or training set so that the testing or training set more accurately reflects real-world conditions. Likewise, by using one or more quality estimation models trained on separate, public data, relatively challenging examples can be selected while limiting extraction of sensitive information from the private data items.

In the case of a training set, the augmenting can result in a training set that results in a more accurate or higher-quality model. For instance, a noise suppressor originally trained using examples with alarm clocks and rain sounds as background noise is likely to suppress noise without introducing undesirable artifacts in real-world usage with these types of background noise. However, if the noise suppressor has not seen vehicular background noise in a sufficient number of training examples, the noise suppressor might introduce undesirable artifacts when suppressing noise for audio with vehicular sounds in the background. By training or tuning such a model with an augmented testing or training set having vehicular background noise examples, the model is more likely to suppress vehicular background noise without introducing undesirable artifacts when deployed.

Similarly, testing a variety of models using a test set that does not represent real-world conditions can result in inaccurate test results or inadvertently selecting a model that is ill-suited for certain real-world scenarios. For instance, noise suppressor A might out-perform noise suppressor B on test examples with alarm clocks or rain in the background, but noise suppressor B might perform far better with vehicular traffic in the background. A test set with alarm clock and rain noise examples but no traffic examples might result in selecting noise suppressor A even for users that might actually prefer noise suppressor B, e.g., a user that does not use an alarm clock, lives in a dry climate with infrequent rain, and lives in a busy city with a lot of traffic noise.

The disclosed sampling techniques also can allow for efficient testing and training. As noted above, the disclosed techniques can produce small samples (e.g., 1% of total available private data items) that are sufficiently representative of the overall repository that very accurate stack ranking of models can be performed. For similar reasons, training of models using such a sampling approach can be more efficient, e.g., relatively few training examples can be employed to obtain a very accurate model. Viewed from one perspective, examples of over-represented classifications in the original testing or training sets can be replaced with examples from unrepresented or under-represented classifications. Thus, the amount of memory, storage, and/or processor resources involved in testing or training a model can be drastically reduced using the disclosed techniques.

One reason that the disclosed implementations can be used to produce such efficient testing or training sets is that the sampling approaches prioritize difficult examples. In other words, the disclosed sampling approaches can preferentially select data items that are relatively difficult (lower quality labels) to add to an augmented testing or training set. In addition, by sampling from each cluster in the repository of private data items, the disclosed sampling approaches can ensure adequate diversity of the augmented testing or training sets.

### Further Types of Data Items

The preceding discussion provides examples relating to noise removal from audio clips as examples of how to employ the disclosed techniques. However, the invention can be employed to generate augmented testing and training sets for a wide range of applications. For audio clips, testing and training sets can be augmented for testing and training of noise removal models, echo removal models, device distortion removal models, codecs, or models for addressing quality degradation caused by room response, or network loss/jitter issues. For images or video clips, testing and training sets can be augmented for testing and training of image/video healing models, low light enhancement models, image/video sharpening models, image/video denoising models, codecs, or models for addressing quality degradation caused by color balance issues, veiling glare issues, low contrast issues, flickering issues, low dynamic range issues, camera jitter issues, frame drop issues, frame jitter issues, and/or audio video synchronization issues.

### Device Implementations

As noted above with respect to FIG. 1, system 100 includes several devices, including a client device 110, a server 120, a server 130, and a server 140. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 150. Without limitation, network(s) 150 can include one or more local area networks (LANs), wide area networks (WANs), the Internet, and the like.

Various examples are described above. Additional examples are described below. One example includes a method comprising accessing a repository of private data items, the repository providing a distribution of the private data items that is representative of a designated real-world scenario for a machine learning model, assigning classifications to the private data items in the repository, and augmenting a testing or training set for the machine learning model based at least on the classifications of the private data items to obtain an augmented testing or training set, the augmented testing or training set providing a basis for testing or training of the machine learning model and including additional testing or training examples from a particular classification that is unrepresented or under-represented in the testing or training set prior to the augmenting.

Another example can include any of the above and/or below examples where the augmenting comprises synthetically generating the additional testing or training examples.

Another example can include any of the above and/or below examples where the augmenting comprises sampling the additional testing or training examples from the repository of private data item.

Another example can include any of the above and/or below examples where the classifications comprise clusters that are assigned to the private data items using a clustering algorithm.

Another example can include any of the above and/or below examples where the method further comprises training the clustering algorithm using the testing or training set prior to assigning the classifications.

Another example can include any of the above and/or below examples where the method further comprises training the clustering algorithm by mapping the testing or training data items into a feature space using one or more auxiliary tasks.

Another example can include any of the above and/or below examples where the method further comprises determining quality labels for the private data items in the repository, where the augmenting is further based at least on the quality labels for the private data items.

Another example can include any of the above and/or below examples where the augmenting comprises sampling individual private data items from each respective cluster as the additional testing or training examples with a probability that is inversely proportional to a respective quality label for each private data item in the respective cluster.

Another example can include any of the above and/or below examples where the quality labels are determined using a quality estimation model that has been trained using machine learning.

Another example can include any of the above and/or below examples where the private data items comprise audio signals, the quality labels characterize sound quality of the audio signals, the classifications comprise noise categories, and the machine learning model is a noise suppressor.

Another example can include any of the above and/or below examples where the method further comprises performing the sampling in accordance with a designated target distribution for the classifications.

Another example can include any of the above and/or below examples where the method further comprises testing or training the machine learning model with the augmented testing or training set.

Another example can include any of the above and/or below examples where the method further comprises ranking a plurality of machine learning models using the augmented testing or training set.

Another example can include any of the above and/or below examples where the augmenting involves sampling the additional testing or training examples from the repository of private data items with a sampling probability that is proportional to variance across the plurality of machine learning models.

Another example can include any of the above and/or below examples where the augmented testing or training set has a reduced number of testing or training examples from another particular classification that is over-represented in the testing or training set prior to the augmenting.

Another example includes a system comprising a processor and a storage medium storing instructions which, when executed by the processor, cause the system to train one or more machine learning models on a testing or training set using one or more tasks, using the one or more machine learning models, obtain feature maps for private data items from a repository, cluster the private data items into a plurality of clusters based at least on the feature maps, and augment the testing or training set with additional testing or training examples sampled from the plurality of clusters.

Another example can include any of the above and/or below examples where the instructions, when executed by the processor, cause the system to augment the testing or training set by sampling individual private data items from the plurality of clusters using a sampling probability that is based at least on a corresponding quality label for each private data item.

Another example can include any of the above and/or below examples where the sampling probability is relatively higher for data items that have relatively lower quality according to the quality label.

Another example can include any of the above and/or below examples where the one or more machine learning models comprise a plurality of neural networks, and the feature maps comprise features from at least two neural networks of the plurality of neural networks.

Another example includes a computer-readable storage medium storing instructions which, when executed by a computing device, cause the computing device to perform acts comprising providing an input signal into a data enhancement model that has been trained using an augmented training set that includes synthetic training examples that have been augmented with additional training examples that are identified using a repository of private data items and outputting an enhanced signal produced by the data enhancement model from the input signal.

Another example can include any of the above and/or below examples where wherein the data enhancement model comprises a noise suppressor, the additional training examples are selected from a repository comprising recordings of audio or video calls among customers, and the synthetic training examples are generated by adding noise to publicly-available audio clips.

### Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
accessing a repository of private data items, the repository providing a distribution of the private data items that is representative of a designated real-world scenario for a machine learning model;
assigning classifications to the private data items in the repository; and
augmenting a testing or training set for the machine learning model based at least on the classifications of the private data items to obtain an augmented testing or training set,
the augmented testing or training set providing a basis for testing or training of the machine learning model and including additional testing or training examples from a particular classification that is unrepresented or under-represented in the testing or training set prior to the augmenting.

2. The method of claim 1, wherein the augmenting comprises synthetically generating the additional testing or training examples.

3. The method of claim 1, wherein the augmenting comprises sampling the additional testing or training examples from the repository of private data items.

4. The method of claim 3, wherein the classifications comprise clusters that are assigned to the private data items using a clustering algorithm.

5. The method of claim 4, further comprising:
training the clustering algorithm using the testing or training set prior to assigning the classifications.

6. The method of claim 5, further comprising:
training the clustering algorithm by mapping the testing or training data items into a feature space using one or more auxiliary tasks.

7. The method of claim 3, further comprising:
determining quality labels for the private data items in the repository,
wherein the augmenting is further based at least on the quality labels for the private data items.

8. The method of claim 7, wherein the augmenting comprises sampling individual private data items from each respective cluster as the additional testing or training examples with a probability that is inversely proportional to a respective quality label for each private data item in the respective cluster.

9. The method of claim 7, wherein the quality labels are determined using a quality estimation model that has been trained using machine learning.

10. The method of claim 9, wherein the private data items comprise audio signals, the quality labels characterize sound quality of the audio signals, the classifications comprise noise categories, and the machine learning model is a noise suppressor.

11. The method of claim 3, further comprising:
performing the sampling in accordance with a designated target distribution for the classifications.

12. The method of claim 1, further comprising:
testing or training the machine learning model with the augmented testing or training set.

13. The method of claim 1, further comprising:
ranking a plurality of machine learning models using the augmented testing or training set.

14. The method of claim 13, wherein the augmenting involves sampling the additional testing or training examples from the repository of private data items with a sampling probability that is proportional to variance across the plurality of machine learning models.

15. The method of claim 1, wherein the augmented testing or training set has a reduced number of testing or training examples from another particular classification that is over-represented in the testing or training set prior to the augmenting.

16. A system comprising:
a processor; and
a storage medium storing instructions which, when executed by the processor, cause the system to:
train one or more machine learning models on a testing or training set using one or more tasks;
using the one or more machine learning models, obtain feature maps for private data items from a repository;
cluster the private data items into a plurality of clusters based at least on the feature maps; and
augment the testing or training set with additional testing or training examples sampled from the plurality of clusters.

17. The system of claim 16, wherein the instructions, when executed by the processor, cause the system to:
augment the testing or training set by sampling individual private data items from the plurality of clusters using a sampling probability that is based at least on a corresponding quality label for each private data item.

18. The system of claim 17, wherein the sampling probability is relatively higher for data items that have relatively lower quality according to the quality label.

19. The system of claim 18, wherein the one or more machine learning models comprise a plurality of neural networks, and the feature maps comprise features from at least two neural networks of the plurality of neural networks.

20. A computer-readable storage medium storing instructions which, when executed by a computing device, cause the computing device to perform acts comprising:
providing an input signal into a data enhancement model that has been trained using an augmented training set that includes synthetic training examples that have been augmented with additional training examples that are identified using a repository of private data items; and
outputting an enhanced signal produced by the data enhancement model from the input signal.

21. The computer-readable storage medium of claim 20, wherein the data enhancement model comprises a noise suppressor, the additional training examples are selected from a repository comprising recordings of audio or video calls among customers, and the synthetic training examples are generated by adding noise to publicly-available audio clips.
